(19) United States
(12) Patent Application Publication
(10) Pub. No.: US 2026/0057282 A1
(43) Pub. Date: Feb. 26, 2026

(54) DYNAMIC DEVOPS PIPELINE GENERATION

(71) Applicant: Bank of America Corporation, Charlotte, NC (US)

(72) Inventors: Sreeram Raghavan, Chennai Tamil Nadu (IN); Sivarama Krishnan Peruvemba Balasubramanyan, Hyderabad Telangana (IN)

(21) Appl. No.: 18/770,802

(22) Filed: Jul. 12, 2024

(51) Int. Cl. G06N 10/80; G06F 8/70; G06N 10/60

(52) U.S. Cl. CPC G06N 10/80; G06F 8/70; G06N 10/60

(57) ABSTRACT

Apparatus for a dynamic development operations (“DevOps”) pipeline generation may include the current build and release of the source code files and related changed units within a data repository. The data repository may include a plurality of data associated with the current build and release of the source code file. A software system may collect the data from the repository. The collected data may be input into an artificial intelligence or machine learning (“AI/ML”) module. The AI/ML module may use a language learning module (“LLM”) to create a plurality of nodes from the data. The LLM may create a knowledge graph from the nodes. The knowledge graph may be input into a quantum computing system to create attention matrices. The attention matrices may be input into a quantum annealing system to determine the DevOps plan. A transformer neural network (“TNN”) may output and execute the DevOps plan.

### FIELD OF TECHNOLOGY

Aspects of the disclosure relate to development operations (“DevOps”), quantum computing and quantum annealing.

### BACKGROUND OF THE DISCLOSURE

Computer systems use source code files and parameter / configuration files to execute computer readable instructions. DevOps (development operations) systems can detect one or more changes present within the aforesaid files. The DevOps systems detect changes within source code files by retrieving the source code file and/or associated configuration files from a database associated with them. Upon detection, the DevOps systems can then build, unit test, scan, publish and/or deploy the units.

The DevOps system is an automated system and generates the build for each pipeline using the same set of algorithms. As such, the DevOps process takes the same amount of time for each build and release of the source code file regardless of the type of the source code file and/or the change type within the current build. In addition, even though the DevOps system can generate a pipeline for the current build and release of the code / other changed units, the DevOps system cannot predict whether the change in the current build and release of the source code file will successfully achieve the intended target.

Therefore, it would be desirable to create a system that dynamically creates only what is relevant for the current build and release.

It would be further desirable for the system to be a dynamic DevOps pipeline generation system.

It would be yet further desirable for the dynamic DevOps pipeline generation system to dynamically generate a plan to dynamically generate a pipeline for the current build and release, relevant to the set of changes made.

### SUMMARY OF THE DISCLOSURE

Apparatus, methods and systems for a dynamic DevOps pipeline generation is provided.

A dynamic development and operations (“DevOps”) pipeline generation system may include using a DevOps system. A DevOps system involves a process in software development that is used for creating executable files. The DevOps system (and process) includes writing the source code file, creating the deployment file, testing the changes and making the changes available to the user. The DevOps system may integrate and automate the work of software development and technical operations to improve and shorten a system's development lifecycle. DevOps system may reduce the time between changing a source code file and putting the changed source code file into a system. A dynamic DevOps pipeline generation system may be a system that uses DevOps to dynamically detect changes for current build and release.

The dynamic DevOps pipeline generation systems or methods may include collecting a plurality of data. The data may be stored in a repository. The data may be stored in a database. The data may be stored in any other suitable software and/or hardware. The data may be collected using a software system, an artificial intelligence and/or machine learning (“AI/ML”) module and/or any other suitable software or hardware data storage systems. A plurality of data elements may be collected. The plurality of data elements may be collected from the database, the repository and/or any other suitable software and/or hardware. The plurality of collected data elements may be associated with the current build and release of changed units.

The plurality of collected data elements may include a plurality of source code files. The plurality of source code files may be similar to, or associated with, the current build and release of changed units. The plurality of data elements may include the current build and release of changed units.

The plurality of data elements may include a plurality of configuration files. Configuration files, for purposes of this application, may be understood to mean files used to configure the parameters and initial settings for computer programs or applications, server processes and operating systems.

The plurality of data elements may include a plurality of past release notes. The plurality of data elements may include a plurality of test cases. The test cases may be associated with the previous & current builds and release of the changed units. The test cases involve previously detected errors within the previous & current builds. The plurality of data elements may include one or more user manuals. The plurality of data elements may include a plurality of recorded errors and solutions to the recorded errors. The recorded errors may have been errors previously detected within the previous & current builds and release.

Systems may further include tokenizing the collected data. Tokenizing data, for purposes of this application, may be understood to mean the process of substituting a sensitive data element with a non-sensitive equivalent data element. The non-sensitive equivalent data elements may be referred to as a token. The collected data elements may be parsed into non-sensitive equivalent data elements, or tokens. There may be a database, or a dictionary, of the tokens and the associated data. Tokenizing the collected data may include pre-contextual embedding of the tokens. Tokenizing the data may include padding the tokens. Tokenizing the data may include creating a sequence length configuration of each of the tokens. The padding and creating the sequence length configuration may result in the tokens being input in a constant manner.

Systems may further include inputting the tokens and the dictionary into a Large Language Model (“LLM”). The LLM may be a part of an Artificial Intelligence and/or Machine Learning (“AI/ML”) engine. The LLM may be configured to determine, from among the collected data, data relevant to the dynamic DevOps pipeline generation plan. The data within the LLM may be scored based on the data element's relevancy to the dynamic DevOps pipeline generation system. A threshold of relevancy may determine whether the data is relevant to the dynamic DevOps pipeline generation plan. The threshold of relevancy may be that the data element is relevant over 55%, 60%, 65%, 70%, 75%, 80% or any other suitable percentage. Each data element may be scored using a relevancy method. Data elements that score over 55%, 60%, 65%, 70%, 75%, 80% or any other suitable percentage may be input into the knowledge graph. Data elements may be determined to be relevant over a threshold of relevancy. The data may be determined less than a threshold of relevancy. The data determined less than a threshold of relevancy may be determined irrelevant to the knowledge graph. As such, data elements determined to be relevant to the DevOps plan may be used in the knowledge graph.

The LLM may be configured to extract the relevant data from the plurality of tokens. The LLM may use the dictionary to extract the relevant data. There may be a large amount of relevant data. The extracted relevant data may be reduced. The extracted relevant data may be reduced in dimensionality. The extracted relevant data may be reduced in dimensionality in subsequent stages. The extracted relevant data may be input into an auto encoder. The auto encoder may use a Huffman pooling system to reduce the size of the relevant data. The auto encoder may output feature maps from the reduced data. There may be bottleneck features extracted from the feature maps. The LLM may create a plurality of nodes based on the bottleneck features. The LLM may create a knowledge graph using the nodes.

The knowledge graph may include the plurality of nodes and a plurality of edges. The edges may be located in between the nodes, connecting one node to another node. Some nodes may be connected to more than one edge. Each connection between two nodes may represent a relationship. Some nodes may connect with more nodes than other nodes. As such, some nodes may have more relationships than other nodes. The nodes may represent data. The edges may represent relationships between the data. A node may have relationships with over a threshold number of nodes. A threshold number of nodes may be over 20, 25, 30, 35 or any other suitable number of nodes. A node with relationships over a threshold number of nodes may affect over the threshold number of nodes if a change would occur within the node. A node may have relationships with less than a threshold number of nodes. A node with a relationship having less than a threshold number of nodes may affect less than a threshold number of nodes when a change occurs within the node.

Systems may further include inputting the knowledge graph into a quantum computing system. The quantum computing system may use a Hamiltonian to identify relationships among the nodes. The Hamiltonian may convert the nodes into quantum qubits. The Hamiltonian may identify relationships between the nodes when converting the nodes to values. For purposes of this application, relationships may include dependencies of one node upon another node.

Systems may further include converting the relationships into a plurality of quantum attention matrices. The quantum attention matrices may be matrices that define the relationships between the nodes. The quantum attention matrices may represent the type of relationships between each node.

Systems may include a quantum annealing engine. A quantum annealing engine may be a quantum computer system that may find a global minimum of a given objective function. The given objective function may be the quantum attention matrices. An association may be made between each of the quantum attention matrices. The quantum attention matrices may be input into the quantum annealing engine.

The quantum annealing engine may include an Ising model. The quantum annealing engine may use the Ising model to create a logical graph from the quantum attention matrices. The Ising model may use a Quadratic Unconstrained Binary Optimization (“QUBO”) equation to create a logical graph from the quantum attention matrices. The logical graph may have edges and nodes. The edges may be quadratic coefficients. The nodes may be linear coefficients. The edges may link to the nodes. The edges may link one node to another node.

Systems may further include converting the logical graph into a physical graph. Systems may include a state processing engine within the quantum annealing engine. The physical graph may be input into the state processing engine. The state processing engine may anneal the physical graph. The physical graph may have all qubits in a superposition state. The state processing engine may use quantum tunnelling to input the physical graph into an initial Hamiltonian. Quantum tunnelling, for purposes of this application, may be understood to mean a quantum mechanical process in which a quantum particle may pass through a potential energy barrier that, according to classical physics, should not be passable due to the object not having sufficient energy to pass or surmount the barrier. There may be a problem Hamiltonian included in the annealing process. The time and energy of the initial Hamiltonian and the problem Hamiltonian may be measured to determine the lowest energy value. The lowest energy value may be determined and may be output as an exploration.

The quantum annealing process may further include reverse annealing. Traditional quantum annealing may attempt to find a ground, or the lowest energy state, by starting with a simple Hamiltonian and gradually transitioning to the problem Hamiltonian that represents the problem of interest. Reverse annealing, however, may start from the problem Hamiltonian and then transition back to the initial Hamiltonian. The lowest energy value determined from the reverse annealing may be compared to the lowest energy value determined from the quantum annealing. The lowest energy value may be determined using the eigen spectrum. The eigen spectrum may be understood to mean an annealing process with a ground state at the bottom and excited states above the ground states. The lowest energy value may be determined and the exploration may be executed.

Systems may include inputting the measured values from the quantum annealing engine into a transformer neural network (“TNN”). Systems may also include inputting the dictionary into the TNN. The TNN may create and output, based on the values and the dictionary, a DevOps plan to complete the current build and release changes.

Systems may further include changing the current build and release changes using the DevOps plan.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative diagram in accordance with principles of the disclosure;

FIG. 2 shows another illustrative diagram in accordance with principles of the disclosure;

FIG. 3 shows an illustrative flow diagram in accordance with the principles of the disclosure;

FIG. 4 shows another illustrative flow diagram in accordance with the principles of the disclosure;

FIG. 5 shows an illustrative flow chart in accordance with the principles of the disclosure;

FIG. 6 shows another illustrative flow chart in accordance with the principles of the disclosure;

FIG. 7 shows an illustrative diagram in accordance with the principles of the disclosure;

FIG. 8 shows an illustrative flow chart in accordance with the principles of the disclosure; and

FIG. 9 shows another illustrative flow chart in accordance with the principles of the disclosure.

### DETAILED DESCRIPTION OF THE DISCLOSURE

Apparatus, methods and systems for a dynamic DevOps pipeline generation is provided.

A source code file, that is in the process of a build and release, may have one or more changes. The dynamic DevOps pipeline generation may detect the one or more changes within the source code file that is in the process of a build and release. The dynamic DevOps pipeline generation may dynamically detect the one or more changes located within the source code file that is in the process of a build and release.

Methods may include collecting a plurality of data associated with the source code file. The plurality of data may be stored in a repository, a database and/or any other suitable hardware or software. The plurality of data may be collected using a software system. A software system may include one or more databases and one or more servers and/or any other suitable systems. The software system may collect the plurality of data from the repository, database or any other suitable software and/or hardware. The repository may be associated with a plurality of source code files. The repository may be associated with the current build and release of all the changed units.

The source code file may be included with the data collected from the repository. Data collected from the repository may include a plurality of source code files. The plurality of source code files may be associated with the current build and release of all the detected changed units. Data collected from the repository may include a plurality of configuration files. A configuration file, or config file, may be a file that is used to configure the parameters and initial settings for computer programs or applications, server processes and operating systems.

Data collected from the repository may include a plurality of past release notes. Release notes, for purposes of this application, may be understood to mean documents that are distributed with software and/or hardware products. Release notes may be a summary of recent changes, enhancements and fixes in a particular software release. Data collected from the repository may include a plurality of test cases. Test cases are data collected from the repository and may include one or more user manuals. Collected data may include a plurality of previously recorded errors and solutions to the recorded errors. Collected data may include a plurality of attribute lists.

Methods may further include tokenizing the collected data into a plurality of tokens. The software system may tokenize the collected data. Tokenization of the data may include creating a dictionary associated with the tokens. A token, for purposes of this application, may be understood to refer to a sensitive data element. The token may be a non-sensitive equivalent data element. The system may have a database of which tokens correspond to which data elements. The database may be referred to as a vocabulary or dictionary.

Each of the tokens may be embedded. The embedding may be referred to as pre-contextual embedding. The tokens may be truncated and placed in a specific order or sequence. Each of the tokens may be embedded to conform to a fixed length.

Methods may further include inputting the plurality of tokens and the dictionary into an Artificial Intelligence or Machine Learning (“AI/ML”) module. The AI/ML module may store the dictionary. A natural language processing (“NLP”) module, located within the AI/ML module, may process the tokens to parse the tokens and extract relevant data. Relevant data may be data relevant over a threshold of relevancy. Relevant data may include process stages, steps within each stage, definitions and key terms, service lease agreements (“SLAs”), error codes, messages and/or any other suitable data. Relevant data may be determined to be relevant based on the changes detected in the changed units that are currently being built for release. Data relevant to the current build and release of the changed units may be data that may assist the DevOps system, and provide data elements, that may be associated with the build of the file for deployment.

A large language module (“LLM”), located within the AI/ML module may create nodes based on the tokens and the relevant data. The LLM may use the nodes to create a knowledge graph. A knowledge graph may include a plurality of nodes and a plurality of edges. The edges may represent relationships. The relationships may be understood to mean dependencies of one node upon another node. The edges may be a line that connects one node to another node. Some of the plurality of nodes be connected to over a threshold of edges. As such, a plurality of nodes may depend on over a threshold of other nodes. A node from among the plurality of nodes may be connected to less than a threshold of nodes. As such, the nodes may be connected less than a threshold of nodes. A threshold of nodes may be 10 nodes, 100 nodes, 1000 nodes, 10000 nodes or any other suitable number of nodes.

Methods may further include inputting the knowledge graph into a quantum computing system. The quantum computing system may convert the nodes and edges into values or quantum qubits. The quantum computing system may use a Hamiltonian to convert the nodes into quantum qubits. The quantum computing system may use the quantum qubits to identify relationships between the nodes. The relationships may be identified by placing the quantum qubits into a plurality of quantum attention matrices.

Methods may further include inputting the plurality of quantum attention matrices into a quantum annealing engine. The quantum annealing engine may convert the plurality of quantum attention matrices into values using an Ising model. The Ising model may use a Quadratic Unconstrained Binary Optimization (“QUBO”) equation to convert the plurality of quantum attention matrices into values. The values may be placed in a logical graph. The quantum annealing engine may convert the logical graph into a physical graph. The physical graph may be annealed to determine a lowest energy level associated with a plurality of qubits from the physical graph.

Methods may further include inputting the measured value of the lowest energy level, or the lowest energy value, into a Transformer Neural Network (“TNN”). The TNN may be a part of the AI/ML model. The TNN may create an output. The output may be based on the lowest energy value. The lowest energy value may be used to create a dynamic DevOps pipeline generation plan for the error including source code file.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

The drawings show illustrative features of apparatus and methods in accordance with the principles of the invention. The features are illustrated in the context of the selected embodiments. It will be understood that features shown in connection with one of the embodiments may be practiced in accordance with the principles of the invention along with features shown in connection with another of the embodiments.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer readable data structures.

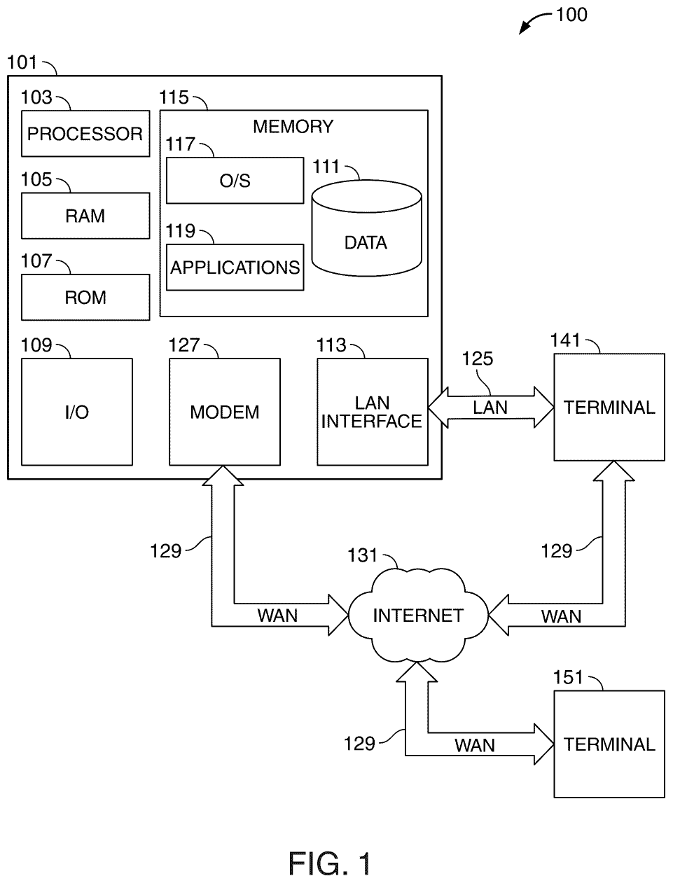

FIG. 1 shows an illustrative block diagram of system 100 that includes computer 101. Computer 101 may alternatively be referred to herein as a “server” or a “computing device.” Computer 101 may be a workstation, desktop, laptop, tablet, smart phone, or any other suitable computing device. Elements of system 100, including computer 101, may be used to implement various aspects of the systems and methods disclosed herein.

Computer 101 may have a processor 103 for controlling the operation of the device and its associated components, and may include RAM 105, ROM 107, input/output module 109, and a memory 115. The processor 103 may also execute all software running on the computer—e.g., the operating system and/or voice recognition software. Other components commonly used for computers, such as EEPROM or Flash memory or any other suitable components, may also be part of the computer 101.

The memory 115 may be comprised of any suitable permanent storage technology—e.g., a hard drive. The memory 115 may store software including the operating system 117 and application(s) 119 along with any data 111 needed for the operation of the system 100. Memory 115 may also store videos, text, and/or audio assistance files. The videos, text, and/or audio assistance files may also be stored in cache memory, or any other suitable memory. Alternatively, some or all of computer executable instructions (alternatively referred to as “code”) may be embodied in hardware or firmware (not shown). The computer 101 may execute the instructions embodied by the software to perform various functions.

Input/output (“I/O”) module may include connectivity to a microphone, keyboard, touch screen, mouse, and/or stylus through which a user of computer 101 may provide input. The input may include input relating to cursor movement. The input/output module may also include one or more speakers for providing audio output and a video display device for providing textual, audio, audiovisual, and/or graphical output. The input and output may be related to computer application functionality.

System 100 may be connected to other systems via a local area network (LAN) interface 113.

System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129 but may also include other networks. When used in a LAN networking environment, computer 101 is connected to LAN 125 through a LAN interface or adapter 113. When used in a WAN networking environment, computer 101 may include a modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit a user to retrieve web pages from a web-based server. The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory.

Additionally, application program(s) 119, which may be used by computer 101, may include computer executable instructions for performing various tasks. Application program(s) 119 (which may be alternatively referred to herein as “plugins,” “applications,” or “apps”) may include computer executable instructions for performing various tasks.

Computer 101 and/or terminals 141 and 151 may also be devices including various other components, such as a battery, speaker, and/or antennas (not shown).

Terminal 151 and/or terminal 141 may be portable devices such as a laptop, cell phone, Blackberry TM, tablet, smartphone, or any other suitable device for receiving, storing, transmitting and/or displaying relevant information. Terminals 151 and/or terminal 141 may be other devices. These devices may be identical to system 100 or different. The differences may be related to hardware components and/or software components.

Any information described above in connection with database 111, and any other suitable information, may be stored in memory 115. One or more of applications 119 may include one or more algorithms that may be used to implement features of the disclosure, and/or any other suitable tasks.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices. It should be noted that such modules may be considered, for the purposes of this application, as engines with respect to the performance of the particular tasks to which the modules are assigned.

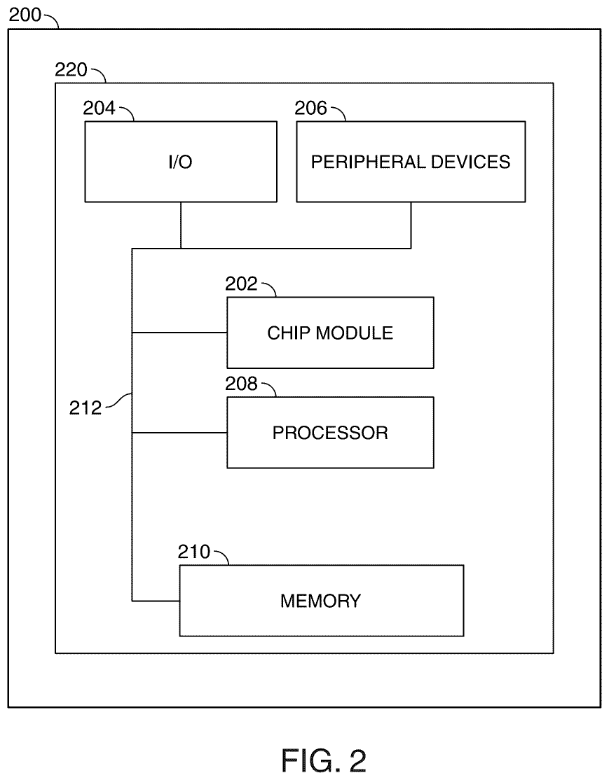

FIG. 2 shows illustrative apparatus 200 that may be configured in accordance with the principles of the disclosure. Apparatus 200 may be a computing machine. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions (which may be alternatively referred to herein as “computer instructions” or “computer code”), applications, signals, and/or any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

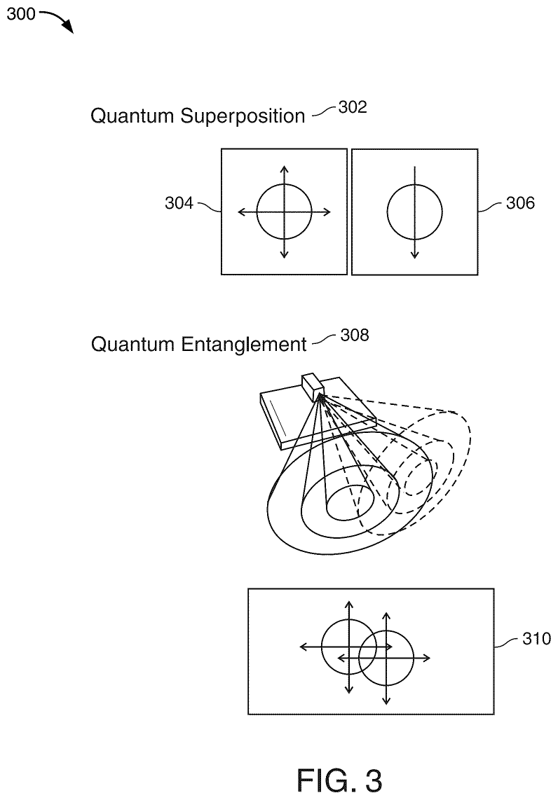

FIG. 3 shows an illustrative diagram. The illustrative diagram shows components of quantum technology. Because quantum technology behaves differently from classical technology, quantum technology provides additional facets to computing. While storage and computing capacity of classical computing grows in a linear fashion, storage and computing capacity of quantum computing grows in an exponential fashion.

Quantum technology may rely on properties of quantum mechanics, such as, for example, quantum superposition, quantum entanglement, quantum tunnelling and quantum interference.

Quantum superposition, shown at 302, states that an unobserved quantum particle, such as a photon, exists in all possible states (spin-up state, a spin-down state or any probability of a spin-up state and spin-down state) simultaneously, as shown at 304. However, when a quantum particle is observed or measured, the quantum particle collapses into a single state, such as a spin-down state, as shown at 306.

Quantum entanglement, shown at 308, states that quantum particles may become connected with one another. The entangled particles correlate with each other, as shown at 310. As such, even when the entangled particles are physically far apart, measuring the state of one of the entangled particles reveals the state of the other entangled particle.

A laser beam fired through a certain type of crystal can cause individual photons to be split into pairs of entangled photons. A pair of entangled photons may be shown at 308.

Quantum tunnelling states that a quantum particle may pass through a potential energy barrier that, according to classical physics, should not be passable due to the object not having sufficient energy to pass or surmount the barrier.

Quantum interference states that a quantum particle may interface with and/or influence itself and/or other particles while in a superposition state. Quantum interference can influence the probability of the state of the particle when the quantum particle is measured.

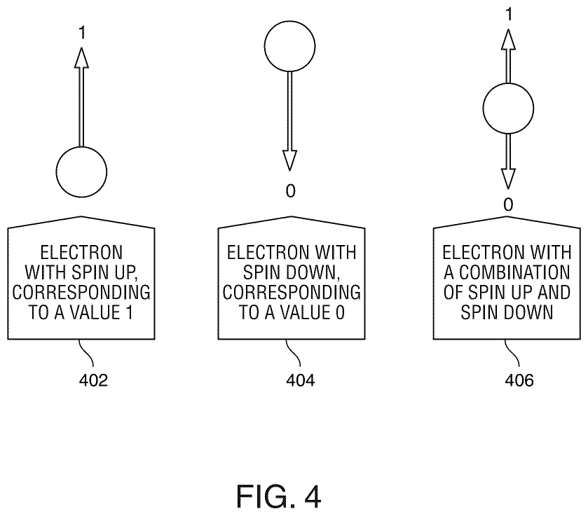

FIG. 4 shows an illustrative diagram. The illustrative diagram shows multiple electrons. A first electron, shown at 402, shows a spin-up, which may correspond, within a quantum processor, to a value of one. A second electron, shown at 404, shows a spin-down, which may correspond, within a quantum processor, to a value of zero. A third electron, shown at 406, shows a combination of a spin-up and a spin-down, which may correspond, within a quantum processor, to a value of both one and zero. A combination state of both spin-up and spin-down may be referred to as superposition.

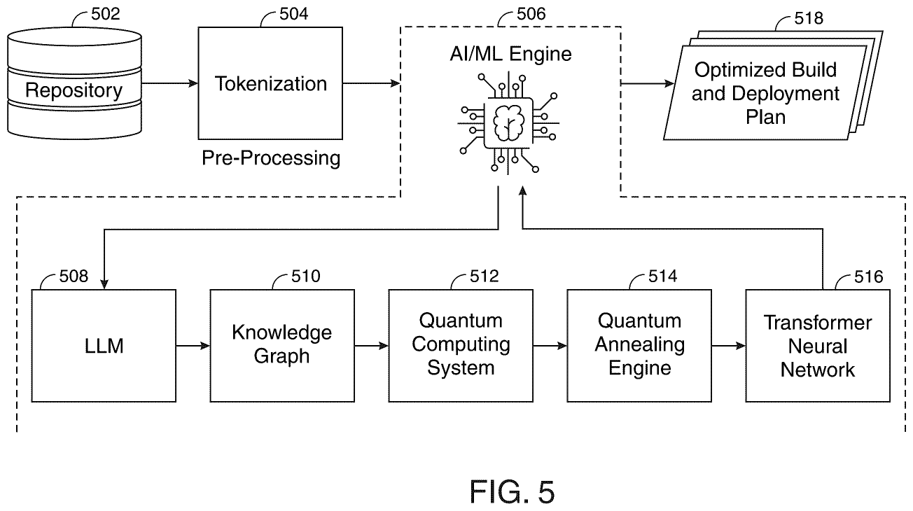

FIG. 5 shows an illustrative flow chart. The flow chart is of the dynamic DevOps pipeline generation system. Repository 502 may be a repository, or a database, which stores a source code file. There may be a change detected within the source code file. Repository 502 may store a plurality of data. The plurality of data elements may be associated with the source code file.

The plurality of data may include additional source code files. The additional source code files may be part of the current build. The additional source code files may be unrelated to the current build and deployment. The plurality of data may include a plurality of configuration files. The plurality of data may further include a plurality of past release notes. The past release notes may be associated with the current build and deployment file. The plurality of past release notes may be associated with the other source code files.

The plurality of data may also include a plurality of test cases. The plurality of test cases may have been performed on the previous or current builds. The plurality of test cases may have been performed on other source code files. However, the plurality of test cases may relate to the current build and deployment file. The plurality of data may include one or more user manuals. The plurality of data may also include a plurality of recorded errors and the solutions to the recorded errors. The plurality of data may include a plurality of attribute lists.

The plurality of data may be collected by a computer system. A computer system may include a processor, a server and a database. The computer system may collect the applicable data from the repository.

The computer system may perform a pre-processing of the data prior to creating the dynamic DevOps pipeline generation plan. Pre-processing of the data may be shown at step 504. Pre-processing the data may include tokenizing the data. Tokenizing the data is the process of substituting a sensitive data element with a non-sensitive equivalent data element. The non-sensitive equivalent may be the token. There may be a database, or a dictionary, of the data corresponding to the tokens.

The tokens may be embedded. The embedding may be pre-contextual embedding. As such, the tokens may each be an identical size. The tokens may be padded to create an identical sequence length configuration among each of the tokens.

The dictionary, as well as each of the tokens may be input at a constant link into an Artificial Intelligence or Machine Learning (“AI/ML”) model 506. AI/ML model 506 may have a Large Language Model (“LLM”) 508. LLM 508 may extract relevant data from the plurality of tokens. LLM 508 may create a plurality of nodes based on the extracted relevant data. The LLM may further use the nodes to create knowledge graph 510. Knowledge graph 510 may include nodes and edges. The nodes may be the nodes created by LLM 508. The edges may be the relationships between each of the nodes. The edges may connect one node to another node.

Knowledge graph 510 may be input into quantum computing system 512. Quantum computing system 512 may identify relationships within knowledge graph 510. Quantum computing system 512 may use a Hamiltonian to identify the relationships in knowledge graph 510. Relationships in the knowledge graph may include the dependency of one node on another node. There may be nodes within the knowledge graph that are dependent on other nodes. Therefore, quantum computing system 512 may determine which nodes may be affected by the change to any node that relates to data within the source code file.

There may be a plurality of identified relationships. The plurality of relationships may be converted into attention matrices. Each of the attention matrices may identify different relationships between the nodes.

The attention matrices may be input into quantum annealing engine 514. An association between the attention matrices may be made. There may be an Ising model within quantum annealing engine 514. The Ising model may use a Quadratic Unconstrained Binary Optimization (“QUBO”) equation to identify quadratic coefficients and linear coefficients from the attention matrices.

Upon identification of the quadratic coefficients and linear coefficients, a logical graph may be created. The logical graph may be converted into a physical graph. The physical graph may be annealed. Annealing the physical graph may determine the lowest energy value of the data provided from the physical graph. There may be a plurality of values, however, the lowest energy value may provide the system with the lowest energy and the fastest way to input a dynamic DevOps change. Annealing of the physical graph may use a problem Hamiltonian to determine the lowest energy value of the system.

The dynamic DevOps pipeline generation system may include a Transformer Neural Network (“TNN”). The TNN may be included in the AI/ML engine. The lowest energy value may be input into the TNN. The TNN may create a dynamic DevOps plan that is relevant to the specific set of changes found within the full set of source code files, based on the lowest energy value.

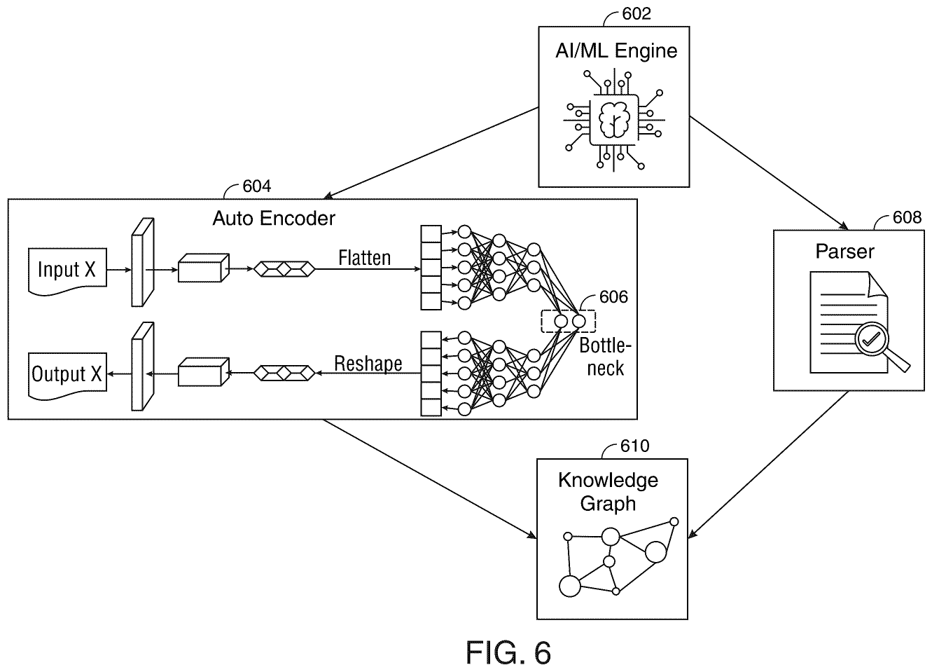

FIG. 6 shows another illustrative flow chart. The flow chart shows the process of the collected data as input into an Artificial Intelligence or Machine Learning (“AI/ML”) engine 602. AI/ML engine 602 may include auto encoder 604. Auto encoder 604 may encode the data received. The data received may be the collected data. The collected data may be encoded using auto encoder 604. Auto encoder 604 may encode and flatten the data. The data may be flattened to create feature maps. The feature maps may create a bottleneck area 606. Bottleneck area 606 may be the reduced collected data. Auto encoder 604 may further reshape the data from bottleneck area 606 to determine if bottleneck area 606 was reduced correctly. AI/ML engine 602 may create a plurality of nodes from bottleneck area 606.

AI/ML engine 602 may include parser 608. Parser 608 may parse the tokens, collected data and dictionary input into AI/ML engine 602.

AI/ML engine 602 may use the plurality of nodes created to further create knowledge graph 610. Knowledge graph 610 may include a plurality of nodes and a plurality of edges. The nodes may be the reduced data. The edges may be the relationships between the nodes. The edges may be represented by lines connecting one node to another node within knowledge graph 610. The nodes may be represented by circles within knowledge graph 610. Each node may have a different number of edges connected to the node. The nodes with over a threshold of edges attached may represent over a threshold of relationships associated with the node. The nodes with less than a threshold of edges attached may represent less than a threshold of relationships associated with that node. Nodes that have greater than a threshold of edges attached may have a plurality of other nodes that depend on the node. Nodes that have less than a threshold of nodes attached may have less than a threshold of nodes that depend on the node.

Each node may have a different number of relationships and a different number of nodes that depend on that node. Knowledge graph 610 may be a graph that provides flexibility to represent data and may add heterogenous nodes to the graph. Knowledge graph 610 may be a knowledge graph that establishes relationships between nodes and may add heterogenous nodes.

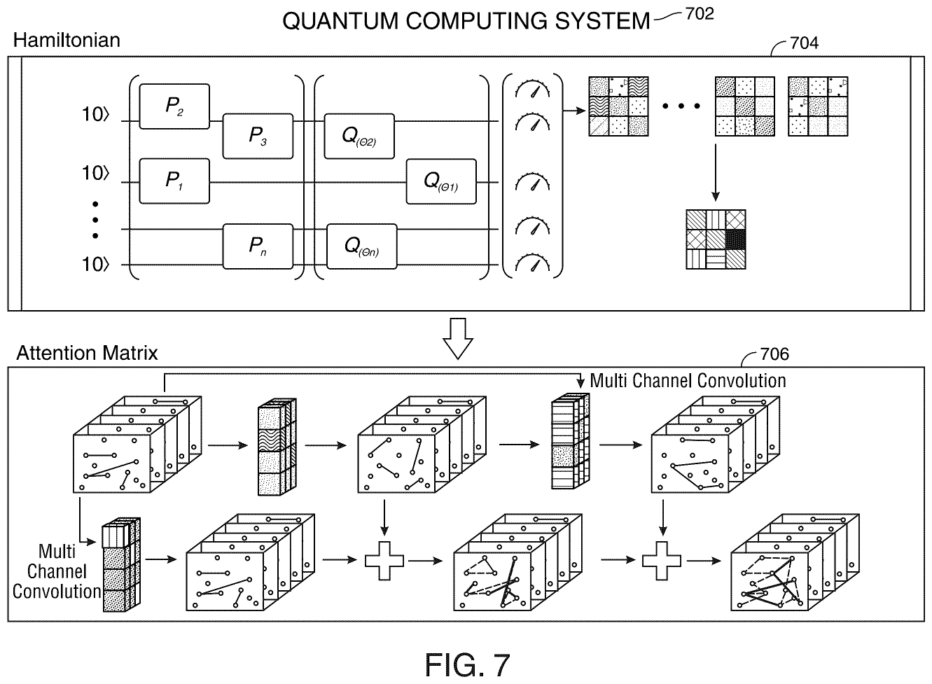

FIG. 7 shows another flow chart. The flow chart shows quantum computing system 702. Quantum computing system 702 is the quantum computing system that converts the nodes into quantum qubits. Quantum computing system 702 may have Hamiltonian 704. A Hamiltonian may be a system that encodes, by creating an energy state for the data, into a physical system in a way that the ground state is the solution. Hamiltonian 704 may encode the nodes into quantum qubits by creating quantum attention matrices of the nodes. The attention matrices output from Hamiltonian 704 may be input into attention matrix 706. Attention matrix 706 may link the nodes and determine hidden relationships within the nodes. Attention matrix 706 may use a Multichannel convolution method to determine the hidden relationships within the nodes.

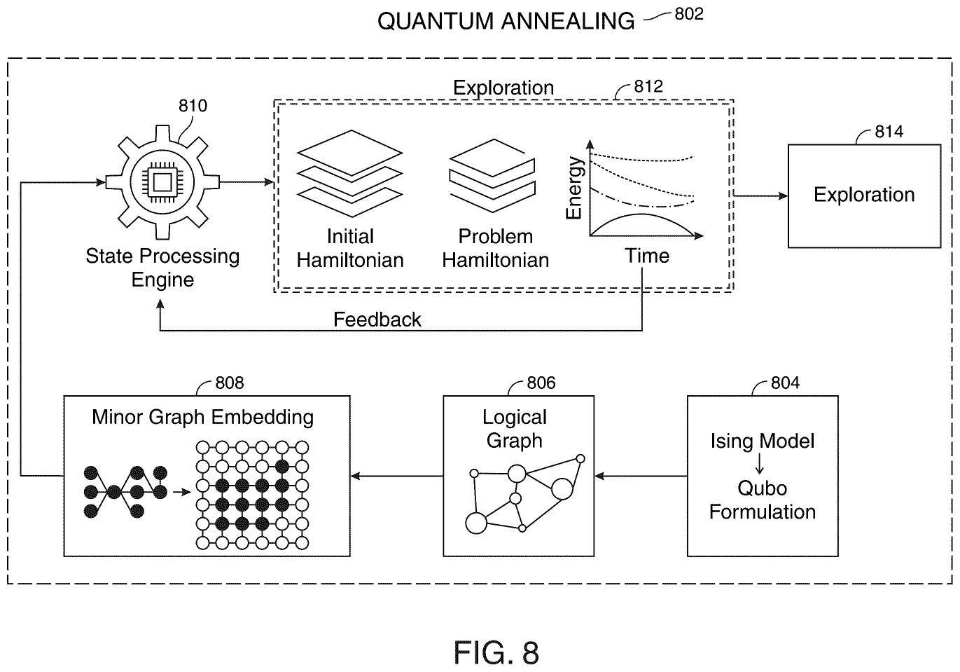

FIG. 8 shows an illustrative diagram. Quantum annealing system 802 may be the quantum system used to anneal the quantum attention matrices. The quantum attention matrices, as shown and described in FIG. 7, may be input into quantum annealing engine 802. Quantum annealing engine 802 may take the quantum attention matrices and use Ising model 804 to create an equation from the quantum attention matrices. Ising model 804 may use a quadratic unconstrained binary optimization (“QUBO”) equation to create an equation from the quantum attention matrices.

Quantum annealing system 802 may create logical graph 806 from the equations. Logical graph 806 may be converted into physical graph 808. The physical graph may be physical graph 808. Physical graph 808 may be based on logical graph 806. Physical graph 808 may be embedded using minor graph embedding.

Quantum annealing system 802 may input the embedded part of the graph into state processing engine 810. State processing engine 810 may process physical graph 808. State processing engine 810 may initialize and anneal physical graph 808. State processing engine 810 may determine the lowest energy value from physical graph 808. State processing engine 810 may perform an exploration, as shown at 812. Physical graph 808 may have all qubits in a super position state. State processing engine 810 may use quantum tunnelling to input physical graph 808 into an initial Hamiltonian. The exploration may include an initial Hamiltonian, or an initial space in which the exploration is performed. State processing engine 810 may determine a problem Hamiltonian, or the space in which the exploration is output. There may a graph in which the output of the problem Hamiltonian may be shown. There may be a problem Hamiltonian included in the annealing process. The time and energy of the initial Hamiltonian and the problem Hamiltonian may be measured to determine the lowest energy value. The lowest energy value may be determined and represented in a graph. A Hamiltonian may have the lowest energy value on the bottom of the graph.

It should be noted that there may be a backward annealing process performed within state processing engine 810. A backward annealing process, for purposes of this application, may be understood to mean an annealing process using a standard computing system. The backward annealing process may determine the lowest energy value of the input values. The outputs from the backward, or reverse, annealing process may be compared to the outputs from the annealing process. If the comparison between the annealing process and the reverse annealing process is determined over a threshold of comparison, state processing engine may output an lowest energy value, as shown at step 814.

The output may be shown at step 814. Step 814 may be the output of the exploration from state processing engine 810. The output may be used to create the dynamic DevOps generation pipeline plan. As such, the annealing process may be complete.

In an embodiment where the comparison between the annealing process and the reverse annealing process is determined less than a threshold of comparison, the annealing process may be performed again. State processing engine 810 may perform the annealing process and the reverse annealing process until the outputs are determined comparable above a threshold of comparison. Upon the determination of comparison above a threshold, the lowest energy value may be output.

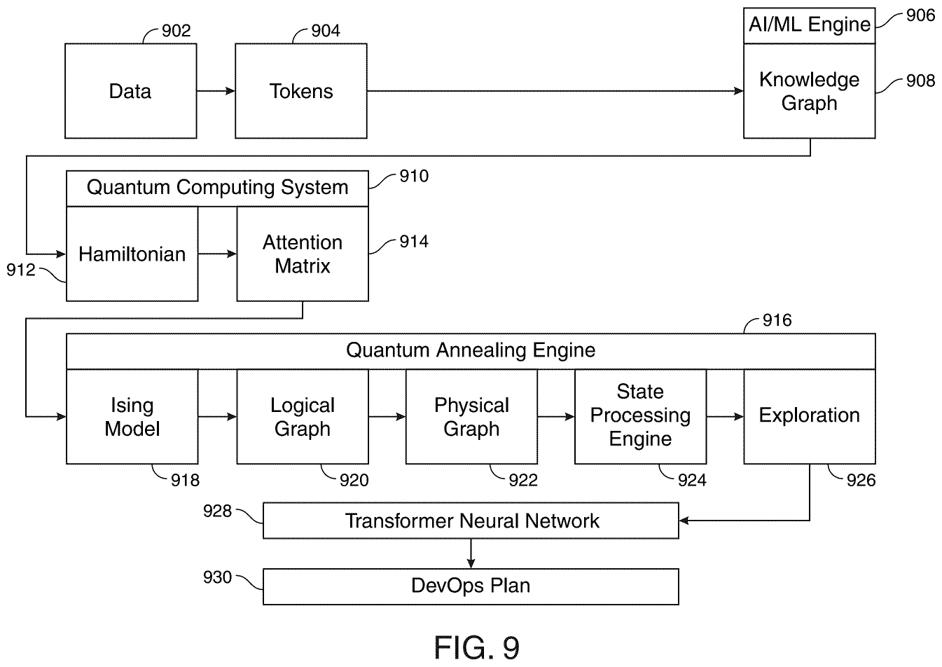

FIG. 9 shows an illustrative flow chart. Data 902 may be collected by a computing system. The computing system may further create tokens 904 from data 902. Tokens 904 may be input into Artificial Intelligence or Machine Learning (“AI/ML”) engine 906. AI/ML engine 906 may create knowledge graph 908 from tokens 906. Knowledge graph 908 may include data from tokens 904 that are determined relevant over a threshold of relevancy.

Knowledge graph 908 may be input into quantum computing system 910. Quantum computing system 910 may take knowledge graph 908 and create values for knowledge graph 908. Quantum computing system 910 may use Hamiltonian 912 to convert knowledge graph 908 into quantum qubits. The quantum qubits may be used to create quantum attention matrices 914.

Attention matrices 914 may be input into quantum annealing engine 916. Quantum annealing engine 916 may anneal attention matrices 914 to determine the lowest energy value for the DevOps generation plan. Ising model 918 may convert attention matrices 914 into equations. Quantum Annealing Engine 916 may create logical graph 920 from the equations output from Ising model 918. Quantum Annealing Engine 916 may convert logical graph 920 into physical graph 922.

Physical graph 922 may be input into state processing engine 924. The annealing process may occur in state processing engine 924. Upon completion of the annealing process, state processing engine 924 may output the lowest energy value determined from the annealing process. The lowest energy value output may be exploration 926.

Exploration 926 may be input into transformer neural network 928. Transformer neural network 928 may create a DevOps plan based on exploration 926. Transformer neural network 928 may output DevOps plan 930 to be used in the dynamic DevOps pipeline generation.

Thus, a dynamic DevOps pipeline generation is provided. Persons skilled in the art will appreciate that the present invention can be practiced by other than the described embodiments, which are presented for purposes of illustration rather than of limitation. The present invention is limited only by the claims that follow.

What is claimed is:

1. A method for providing a dynamic development operations (“DevOps”) pipeline generation, said dynamic DevOps pipeline generation dynamically factoring in changes located within a current build of a deployment file, the method comprising:
collecting, using a software system, a plurality of data associated with the current build of a deployment file;
tokenizing the plurality of data, the tokenizing producing a plurality of tokens;
inputting the tokens into a large language model (“LLM”), wherein the LLM is configured to:
extract data determined to be relevant over a threshold of relevancy from the plurality of tokens;
create nodes, within the LLM, said nodes being based on the relevant data; and
create a knowledge graph based on the relevant data and the nodes;
inputting the knowledge graph into a quantum computing system, wherein the quantum computing system is configured to:
use a Hamiltonian to convert the knowledge graph into quantum qubits; and
identify, based on the quantum qubits, relationships between the nodes, said identify by converting the relationships into a plurality of quantum attention matrices;
inputting the plurality of quantum attention matrices into a quantum annealing engine, wherein the quantum annealing engine is configured to:
convert the quantum attention matrices into a logical graph, said convert using an Ising model;
convert the logical graph into a physical graph;
anneal the physical graph to determine a lowest energy level associated with a plurality of qubits from the physical graph; and
input a measured value of the lowest energy level into a Transformer Neural Network (“TNN”), the TNN configured to:
create an output, said output comprising a dynamic DevOps pipeline generation plan for the current build and release of a source code file; and
use the dynamic DevOps pipeline generation plan to detect changes relevant to the current build and release of the deployment file.

2. The method of claim 1 further comprising collecting the plurality of data from a repository associated with the current build and release of the deployment file.

3. The method of claim 1 said collecting further comprising the plurality of data including the current build and release of the source code file, a plurality of configuration files, a plurality of past release notes, a plurality of test cases, one or more user manuals, a plurality of recorded errors and solutions, and a plurality of attribute lists.

4. The method of claim 1 said tokenizing further comprising:
creating a vocabulary associated with the tokens;
embedding the tokens, said embedding associating each word in the vocabulary with a dense vector representation; and
creating a sequence length configuration of each of the tokens.

5. The method of claim 1 wherein the knowledge graph comprises nodes and edges, the edges configured to connect each of the nodes to a plurality of other nodes and wherein the attention matrices link each of the nodes to one or more nodes, said linking nodes with relationships.

6. The method of claim 1 wherein inputting the tokens into the LLM further comprises inputting the collected data and a dictionary.

7. A dynamic DevOps pipeline generation system, said dynamic DevOps pipeline generation system for dynamically detecting changes located within a current build and release of a deployment file, the dynamic DevOps pipeline generation system comprising:
a software system configured to:
collect a plurality of data from a repository, said collecting with a software system;
create a plurality of tokens, said creating from the collected data; and
input the tokens into a Large Language Model (“LLM”) located within an artificial intelligence or machine learning (“AI/ML”) model, wherein the LLM is configured to:
extract data determined relevant over a predetermined level of relevancy from the tokens;
create a plurality of nodes from the extracted data;
create a knowledge graph based on the extracted data and the nodes, said knowledge graph comprising a plurality of nodes and a plurality of edges; and
input the knowledge graph into a quantum computing engine, wherein the quantum computing engine is configured to:
identify relationships between the plurality of nodes and edges from within the knowledge graph, said identify using a Hamiltonian; and
convert the relationships into a plurality of quantum attention matrices;
a quantum annealing engine, the quantum annealing engine configured to:
ingest the quantum attention matrices;
create a logical graph, said create with an Ising model;
associate the logical graph with a physical graph;
anneal the physical graph to determine a lowest energy level associated with a plurality of qubits from the physical graph; and
input a measured value of the lowest energy level into a Transformer Neural Network (“TNN”), the TNN configured to:
create an output, said output comprising a dynamic DevOps pipeline generation plan for the current build and release of all units relevant to the changes only.

8. The system of claim 7 wherein the plurality of data includes the current build and release of the source code file, a plurality of configuration files, a plurality of past release notes, a plurality of test cases, one or more user manuals, a plurality of recorded errors and solutions and a plurality of attribute lists.

9. The system of claim 7 wherein the tokenizing further comprises:
creating a dictionary associated with the tokens;
embedding the tokens, said embedding associating each word in the dictionary with a dense vector representation; and
creating a sequence length configuration of each of the tokens.

10. The system of claim 7 wherein the knowledge graph comprises nodes and edges, the edges configured to connect each of the nodes to a plurality of other nodes; and
wherein the attention matrices link each of the nodes to one or more nodes, said linking nodes with relationships.

11. Apparatus for a dynamic development operations (“DevOps”) pipeline generation, the apparatus comprising:
a current build and release of a deployment file, ;
a data repository, the data repository associated with a source code file;
a software system, wherein the software system is configured to:
collect a plurality of data from the data repository;
preprocess the data, said preprocess to create a plurality of tokens, said created from the collected data;
an artificial intelligence or machine learning (“AI/ML”) module, the module comprising a large language model (“LLM”), wherein the tokens are input into the LLM;
a plurality of nodes, the plurality of nodes created from the tokens;
a knowledge graph, said knowledge graph created based on the data;
a quantum computing system, the quantum computing system comprising:
a Hamiltonian; and
a plurality of quantum attention matrices, wherein the quantum computing system uses the Hamiltonian to create the quantum attention matrices, said create determining relationships between each of a plurality of edges and the nodes within the knowledge graph; and
a quantum annealing engine, the quantum annealing engine comprising:
an Ising model, the Ising model configured to convert the attention matrices into a logical graph;
a physical graph, said physical graph being based upon the logical graph; and
a transformer neural network (“TNN”), the TNN for executing an output from the annealing engine, said output providing a dynamic DevOps pipeline generation.

12. The apparatus of claim 11 wherein the plurality of data collected from with the repository further comprises a plurality of data including the source code file, a plurality of configuration files, a plurality of past release notes, a plurality of test case, one or more user manuals, a plurality of recorded errors and solutions and a plurality of attribute lists.

13. The apparatus of claim 11 wherein the tokenizing performed by the software system further comprises:
creating a vocabulary associated with the tokens;
embedding the tokens, said embedding associating each word in the vocabulary with a dense vector representation; and
creating a sequence length configuration of each of the tokens.

14. The apparatus of claim 11 wherein the knowledge graph comprises nodes and edges, the edges configured to connect each of the nodes to a plurality of other nodes and wherein the attention matrices link each of the nodes to one or more nodes, said linking nodes with relationships.

15. A method for providing a dynamic development operations (“DevOps”) pipeline generation, the method comprising:
collecting, using a software system, a plurality of data associated with a current build and release of a source code file and other relevant changed units;
tokenizing the plurality of data, the tokenizing producing a plurality of tokens;
inputting the plurality of data into a large language model (“LLM”), wherein the LLM is configured to:
extract data determined to be relevant over a threshold of relevancy from the plurality of data;
create nodes, within the LLM, said nodes being based on the relevant data; and
create a knowledge graph based on the relevant data and the nodes;
inputting the knowledge graph into a quantum computing system, wherein the quantum computing system is configured to:
use a Hamiltonian to convert the knowledge graph into quantum qubits; and
identify, based on the quantum qubits, relationships between the nodes, said identify by converting the relationships into a plurality of quantum attention matrices;
inputting the plurality of quantum attention matrices into a quantum annealing engine, wherein the quantum annealing engine is configured to:
convert the quantum attention matrices into a logical graph, said convert using an Ising model;
convert the logical graph into a physical graph;
anneal the physical graph to determine a lowest energy level associated with a plurality of qubits from the physical graph; and
input a measured value of the lowest energy level into a Transformer Neural Network (“TNN”), the TNN configured to:
create an output, said output comprising a dynamic DevOps pipeline generation plan for the current build and release.

16. The method of claim 15 further comprising collecting the plurality of data from a repository associated with a current build and release of the changed units.

17. The method of claim 15 wherein said collecting further comprises the plurality of data including the current build and release of the source code file, a plurality of configuration files, a plurality of past release notes, a plurality of test cases, one or more user manuals, a plurality of recorded errors and solutions, and a plurality of attribute lists.

18. The method of claim 15 wherein the knowledge graph comprises nodes and edges, the edges configured to connect each of the nodes to a plurality of other nodes and wherein the attention matrices link each of the nodes to one or more nodes, said linking nodes with relationships.
